(19) United States
(12) Patent Application Publication
(10) Pub. No.: US 2002/0105689 A1
(43) Pub. Date: Aug. 8, 2002

(54) Scanner

(75) Inventors: Masaaki Otoko, Ichikawa-shi (JP); Hideki Kawabata, Tokyo (JP)

Correspondence Address: OLIFF & BERRIDGE, PLC, P.O. BOX 19928, ALEXANDRIA, VA, 22320, US

(73) Assignee: OTOKO MACHINERY WORKS, LTD., Ichikawa-shi (JP)

(21) Appl. No.: 10/061,195

(22) Filed: Feb. 4, 2002

(30) Foreign Application Priority Data
Feb. 6, 2001 (JP) 2001-30087
Jan. 31, 2002 (JP) 2002-22712

(51) Int. Cl. H04N 1/46

(52) U.S. Cl. 358/505

(57) ABSTRACT

A scanner includes a base frame (1); a table (2) provided on the base frame (1) to mount a sheet-like subject thereon; and a scanner head (3) movably supported on the base frame (1). The scanner head (3) can move straight along a subject mount surface (21) of the table (2).

### BACKGROUND OF THE INVENTION

1. Field of the Invention

The present invention relates to a scanner for use in systems for precisely acquiring image information, such as a plate test system and a length-measuring instrument, and in substrate testing.

2. Description of the Related Art

A general scanner in the art employs a several-millimeter thick, transparent glass plate as a table. A sheet of subject is secured on the glass table in such a manner that the image surface of the subject is directed to the glass plate and the rear surface thereof is pressed by a cover that has a material such as sponge adhered thereon. A line image sensor is located beneath the glass table to take an optical image of the subject during a constant speed scanning of the optical image of the subject through the glass plate.

A plate test system in CTP (Compute to Plate) requires a high-precision scanner to read a plate produced by the CTP system and compare the read data with post-RIP (Raster Image Processor) final data created in a DTP (Desk Top Publishing) system. Such a high-precision scanner is also required for the use in computing a distance between readings on map information and for the use in testing defects on a substrate.

The conventional scanner is designed to scan the optical image through the glass plate. Therefore, if the scanner is upsized, as the central portion of the glass plate may be bent as deep as several hundred microns, the bend and refractive distortion in the glass plate causes an error. This is a disadvantage of the prior art. The conventional scanner scans the line image sensor at a constant speed while using cloaks for a control computer in time synchronization to control a scanning pitch. Therefore, if an error in the scanning speed occurs 0.01%, an error of about 2 pixels (about 100 microns) appears in the case of scanning 1,000 mm at 400 DPI. This is another disadvantage of the prior art.

### SUMMARY OF THE INVENTION

The present invention has been made in consideration of the above situation and accordingly has an object to provide a scanner capable of extremely high-precise image scanning even if it is upsized.

The present invention is provided with a scanner, which comprises a table having a subject mount surface for mounting a sheet-like subject thereon; a scanner head arranged opposite to the subject mount surface of the table and linearly movable along the subject mount surface, the scanner head including a line imager for imaging the subject mounted on the subject mount surface; a head drive mechanism including a drive shaft extending along the subject mount surface for driving the scanner head straight along the drive shaft; a linear scale for providing a signal to detect a location of the scanner head in the direction of the drive shaft; and image capture means for capturing an image of the subject from the imager based on the signal from the linear scale.

According to the present invention, the scanner head equipped with the imager opposes to the subject mount surface, and the subject mounted on the subject mount surface is directly scanned through no glass plate and the like. Therefore, the problematic bend and refractive distortion of the glass plate is never caused. In addition, according to the present invention, the location of the scanner head in the direction of the drive shaft is detected on the basis of the signal from the linear scale to control the scanning pitch for the image of the subject. Therefore, a precision of the scanning pitch to a running distance can be greatly improved. With these effects, the present invention can achieve a high-precision scanner.

The table may comprise a plate composed of a material that can maintain flatness, such as metal, stone and glass, which is mounted on a base frame. To secure the subject precisely, the table preferably includes an attractive mechanism for attracting the subject to secure it on the subject mount surface. Similarly, the table preferably includes a positioning and securing pin on the periphery for positioning the subject on the subject mount surface.

To stabilize the drive system and to improve the straight movement of the scanner head, the scanner head preferably includes a drive frame movably supported on both sides of the base frame interposing a pair of linear bearings therebetween. In this case, the head drive mechanism includes a ball screw mechanism including a ball screw as the drive shaft located at about the midpoint between the pair of linear bearings and in parallel with the linear bearings.

To preclude an error in movement of the scanner head as far as possible, the linear scale is preferably arranged in the vicinity of the drive shaft and in parallel with the drive shaft.

The scanner head may include a drive frame movably supported on both sides of the base frame interposing a pair of linear bearings therebetween; a line image sensor, or an imager, mounted on the drive frame; and an optical system for shifting the optical path by about 90° to introduce an optical image of the subject mounted on the subject mount surface of the table into the line image sensor. Such the configuration is effective to ensure a distance from the subject to the line image sensor without the need for heightening the scanner head too much.

### BRIEF DESCRIPTION OF THE DRAWINGS

The present invention will be more fully understood from the following detailed description of the preferred embodiments with reference to the accompanying drawings, in which:

FIG. 1 is an external perspective view of a scanner according to an embodiment of the present invention;

FIGS. 2A and 2B shown a table in the scanner in plan and side views;

FIG. 3 is a plan view of the scanner in a state, from which the table and a scanner head are removed;

FIG. 4 is a side view showing an outlined arrangement of optical elements in the scanner head of the scanner;

FIG. 5 is a cross-sectional view showing a structure of a table according to another embodiment; and

FIGS. 6A and 6B show a scanner structure according to a further embodiment in a plan view and a cross-sectional view taken along the A-A′ line.

### DETAILED DESCRIPTION OF THE PREFERRED EMBODIMENTS

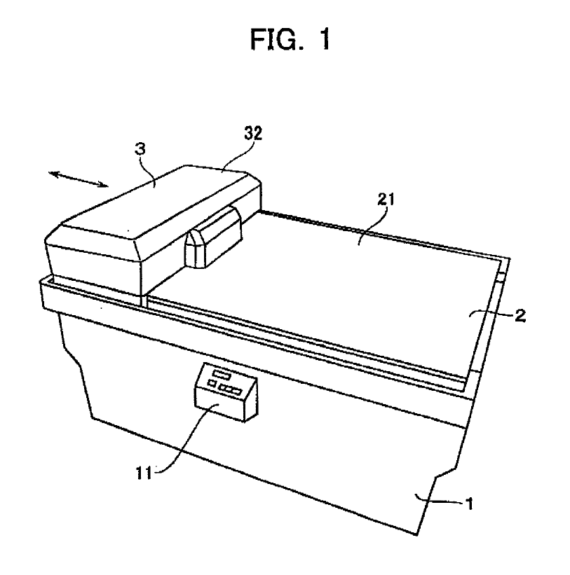

A scanner shown in FIG. 1 is a large one that has a scan range of about 850 mm×1030 mm, for example. This scanner comprises a base frame 1 equipped with a console panel 11 on the side. A table 2 is provided on the base frame 1 to mount a sheet-like subject thereon. A scanner head 3 is supported movably on the base frame 1 so that the scanner head 3 can move straight along a subject mount surface 21 of the table 2.

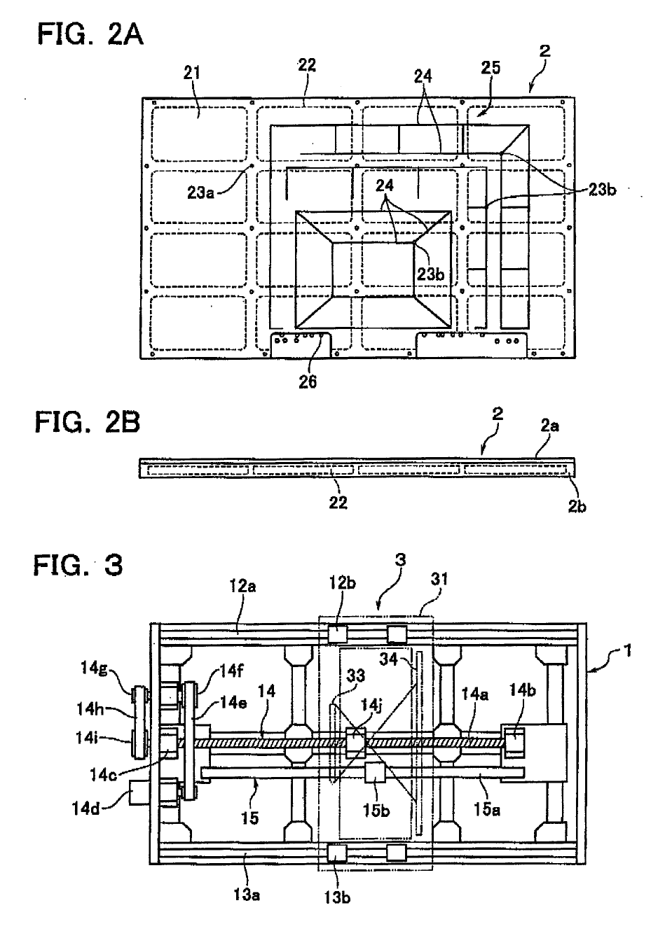

FIG. 2A is a plan view of the table 2 and FIG. 2B a side view thereof.

Preferably, the table 2 is composed of a metal plate. Specifically, the table 2 in this embodiment comprises an aluminum plate 2a precisely machined and controlled to have a bend of 30 microns or below and an aluminum frame 2b that supports the plate. An attractive mechanism 25 is formed in the table 2 to secure a subject on the subject mount surface 21. The attractive mechanism 25 includes air ducts 22 formed inside the table 2 and narrow grooves 24 patterned in the subject mount surface 21. Small bores 23a, 23b are formed to connect the ducts 22, the subject mount surface 21 and the narrow grooves 24 together. On the periphery of the table 2, positioning pins 26 are provided and employed as the reference to set a subject such as a printing plate of each size at the same location.

FIG. 3 is a plan view of the scanner in a state, from which the table 2 and the scanner head 3 are removed. The base frame 1 has a rigid structure sufficient to prevent from a deforming by external force such as its own weight and an additional load. Provided at both edges in the shorter lateral direction on the table 2 are linear bearings 12a, 13a that extend in the longitudinal direction. The scanner head 3 includes a drive frame 31 of which both edges are supported on the linear bearings 12a, 13a at both sides of the base frame 1 via sliders 12b, 13b so that it can freely move in the longitudinal direction. A ball screw mechanism 14 is arranged at about the center on the base frame 1 and in parallel with the linear bearings 12a, 13a. The ball screw mechanism 14 includes a ball screw 14a, which is suspended in the longitudinal direction over the base frame 1 to serve as a measurement axis. To support both ends of the ball screw 14a, bearings 14b, 14c are employed. A motor 14d is provided to rotationally drive the ball screw 14a via a transmission that includes belts 14e, 14h and pulleys 14f, 14g, 14i. Finally, a movable nut 14j is secured on the drive frame 31 of the scanner head 3.

In the vicinity of the ball screw 14a, a linear scale 15 is located in parallel with the ball screw 14a. The linear scale 15 is of magnetic, optical or capacitive and includes a head unit 15b that is secured on the drive frame 31 and relatively movable against a stationary scale 15a. The linear scale 15 provides pulses indicative of a distance as the scanner head 3 moved. The pulses are introduced into an image capture circuit that contains a counter, not depicted, which counts the pulses for scan synchronization to capture an image from a CCD line image sensor 33.

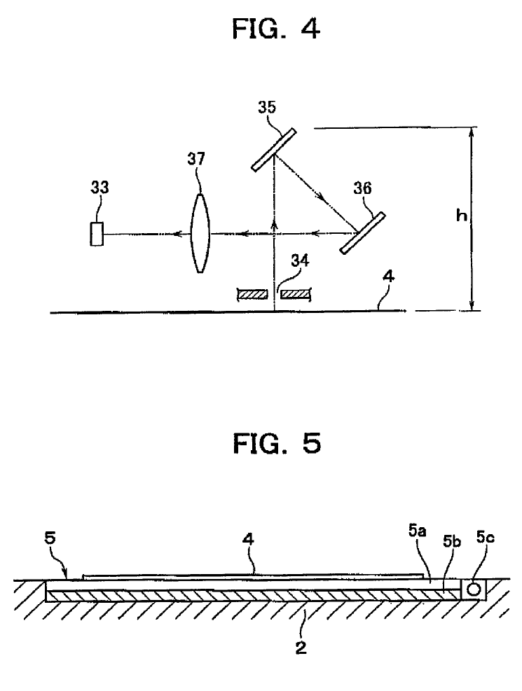

When a head cover 32 of the scanner head 3 is opened, the CCD line image sensor 33 is seen secured on a sensor base not depicted. The CCD line image sensor 33 is employed to take an optical image of the subject through a slit 34 formed in a side of the scanner head 3 facing to the table 2. FIG. 4 outlines optical elements in the scanner head 3 in a side view. As shown, the optical image of a subject 4 passed through the slit 34 is reflected at reflective mirrors 35 and 36 to change its optical path by 90°, and is focused through a lens 37 on the CCD line image sensor 33 for imaging.

Such the configuration is effective to ensure a sufficient optical distance without the need for increasing a height, h, of the scanner head 3 too much.

According to the scanner thus configured, the following effects can be achieved.

(1) It employs direct scanning that scans, from above, the subject mounted on the upper surface of the table 2. This is effective to eliminate an error due to the refractive distortion and bend of the table.

(2) The scanner head 3 is supported at both sides and driven at the center. This is effective to precisely send the head without deviations in the direction of the drive shaft.

(3) The linear scale 15 is located in the vicinity of the drive shaft. This is effective to reduce an error in movement,

(4) Scan is synchronized with distance pulses from the linear scale 15. This is effective to greatly improve a capturing precision against the distance.

(5) The attractive mechanism 25 in the table 2 is operative to secure the sheet-like subject such as a printing in stable and the positioning pin 26 is possible to precisely secure it in place.

In the above embodiment, the scanner head is designed to take an image reflected from the subject. To the contrary, if the subject is a transparent plate film, for example, the film is preferably illuminated from the rear surface to take an image transmitted through it. In this case, a flat light emissive plate is integrated into the table. For example, as shown in FIG. 5, a flat light emissive plate 5 is embedded in the upper surface of the table 2. A light emissive surface of the plate 5 is employed as the subject mount surface 21, on which a subject 4 is mounted. The flat light emissive plate 5 is composed of a transparent resinous plate 5a, a reflective plate 5b adhered thereto and a line light source 5c arranged at their side. The resinous plate 5a contains particulate dispersed therein for scattering light.

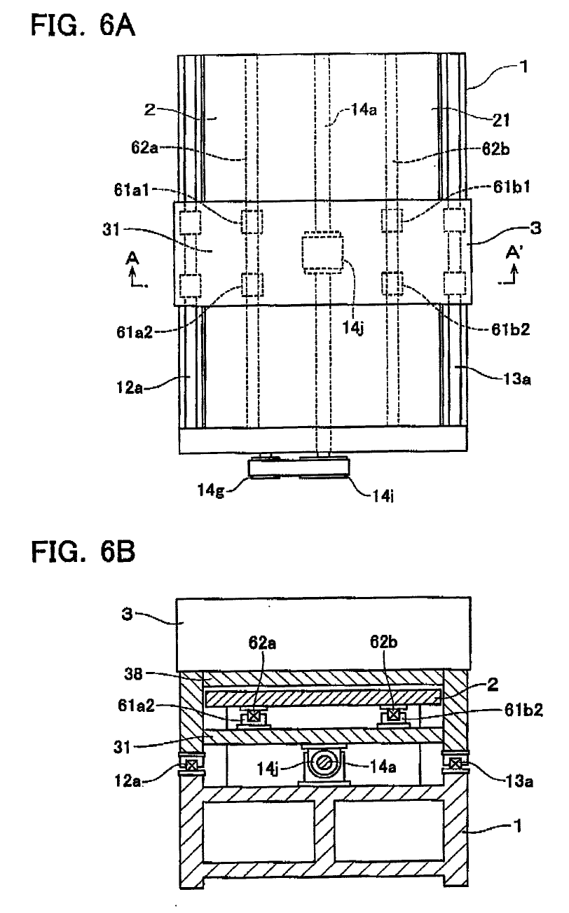

FIGS. 6A-B show another embodiment of a scanner which has a support mechanism for preventing the table 2 from bending, in a plan view and a cross-sectional view taken along the A-A′ line. The same reference numerals as those in the previous embodiment are employed to denote the corresponding components in this embodiment. The scanner head 3 is constructed to sandwich the table 2 between a substrate 38 and a drive frame 31. This is the same as the above-described embodiment. In this embodiment, on the upper surface of the drive frame 31, each two recessed guides 61a1, 61a2 and 61b1, 61b2 are formed at locations of certain distances apart from both edges in the short lateral direction of the table 2. On the lower surface of the table 2, two rails 62a, 62b are continuously formed in the longitudinal direction of the table 2 for sliding these guides 61a1, 61a2, 61b1, 61b2.

Through the support mechanism including the guides 61a1, 61a2, 61b1, 61b2 and rails 62a, 62b, the drive frame 31 of the scanner head 3 can support the table 2 at locations apart certain distances from both edges in the short lateral direction of the table 2. In this case, even if the table 2 slightly bends due to its own weight and so forth, the bend can be corrected at least at the location of the scanner head 3. As a result, it is possible to maintain a constant distance between the subject mount surface 21 of the table 2 and the scanner head 3. This leads to possible high-precise image scanning.

As obvious from the forgoing, according to the present invention, the scanner head equipped with the imager opposes to the subject mount surface, and the subject mounted on the subject mount surface is directly scanned through no glass plate and the like. Therefore, the problematic bend and refractive distortion of the glass plate is never caused. In addition, the location of the scanner head in the direction of the drive shaft is detected on the basis of the signal from the linear scale to control the scanning pitch for the image of the subject. Therefore, a precision of the scanning pitch to a running distance can be greatly improved. Accordingly, a high-precision scanner can be achieved.

Having described the embodiments consistent with the invention, other embodiments and variations consistent with the invention will be apparent to those skilled in the art. Therefore, the invention should not be viewed as limited to the disclosed embodiments but rather should be viewed as limited only by the spirit and scope of the appended claims.

What is claimed is:

1. A scanner comprising:
a table having a subject mount surface for mounting a sheet-like subject thereon;
a scanner head arranged opposite to said subject mount surface of said table and linearly movable along said subject mount surface, said scanner head including a line imager for imaging said subject mounted on said subject mount surface;
a head drive mechanism including a drive shaft extending along said subject mount surface for driving said scanner head straight along said drive shaft;
a linear scale for providing a signal to detect a location of said scanner head in the direction of said drive shaft; and
image capture means for capturing an image of said subject from said imager based on said signal output from said linear scale.

2. The scanner according to claim 1, wherein said table comprises a metal plate mounted on a base frame.

3. The scanner according to claim 1, wherein said table includes an attractive mechanism for attracting said subject to secure it on said subject mount surface.

4. The scanner according to claim 1, wherein said table includes a positioning and securing pin on the periphery for positioning said subject on said subject mount surface.

5. The scanner according to claim 2, wherein said scanner head includes a drive frame movably supported on both sides of said base frame, interposing a pair of linear bearings therebetween, for mounting said imager thereon,
said head drive mechanism comprising a ball screw mechanism including a ball screw as said drive shaft located at about the midpoint between said pair of linear bearings and in parallel with said linear bearings.

6. The scanner according to claim 1, wherein said linear scale is arranged in the vicinity of said drive shaft and in parallel with said drive shaft.

7. The scanner according to claim 2, wherein said scanner head includes
a drive frame movably supported on both sides of said base frame, interposing a pair of linear bearings therebetween, for mounting said imager thereon; and
an optical system for shifting the optical path by about 90° to introduce an optical image of said subject mounted on said subject mount surface of said table into said imager.

8. The scanner according to claim 1, wherein said imager comprises a CCD line sensor.

9. The scanner according to claim 1, wherein said table includes a flat light emissive plate having a light emissive surface as said subject mount surface.

10. A scanner comprising:
a table having a subject mount surface for mounting a sheet-like subject thereon;
a base frame for mounting said table thereon;
a scanner head arranged opposite to said subject mount surface of said table and linearly movable along said subject mount surface, said scanner head including a line imager for imaging said subject mounted on said subject mount surface;
a head drive mechanism including a drive shaft extending along said subject mount surface for driving said scanner head straight along said drive shaft;
a linear scale for providing a signal to detect a location of said scanner head in the direction of said drive shaft; and
image capture means for capturing an image of said subject from said imager based on said signal from said linear scale,
wherein said scanner head includes a drive frame movably supported on both sides of said base frame, interposing a pair of linear bearings therebetween, for mounting said imager thereon, said drive frame of said scanner head having a support mechanism for slidably supporting said table within certain distances from both sides of said base frame on the upper surface thereof.
